(19) United States
(12) Patent Application Publication
(10) Pub. No.: US 2015/0317655 A1
(43) Pub. Date: Nov. 5, 2015

(54) CROWDSOURCED NEWS END-TO-END SYSTEM

(71) Applicant: newsbloom, Inc., West Hollywood, CA (US)

(72) Inventors: Hugh Douglas MYERS, Venice, CA (US); Michael Alan Cummings, West Hollywood, CA (US); Thomas Scott Suiter, San Francisco, CA (US)

(21) Appl. No.: 14/702,285

(22) Filed: May 1, 2015

Related U.S. Application Data
(60) Provisional application No. 61/987,380, filed on May 1, 2014.
(60) Provisional application No. 62/018,489, filed on Jun. 27, 2014.

(51) Int. Cl. G06Q 30/02

(52) U.S. Cl. CPC G06Q 30/0205

(57) ABSTRACT

Disclosed herein are system, method, and computer program product embodiments for sourcing, processing, and distributing information in general, and more specifically, information that is generally news or news-related in nature. An embodiment operates by determining a geographic area and selecting stories associated with the geographic area. The embodiment further generates map display information for the geographic area including a plurality of selectable indicators, each corresponding to one of the one or more stories, and transmits the map display information to an interactive user device.

### CROSS-REFERENCE TO RELATED APPLICATIONS

The present application claims the benefit of U.S. Provisional Application No. 61/987,380, filed May 1, 2014, and U.S. Provisional Application No. 62/018,489, filed Jun. 27, 2014, each of which are incorporated by reference herein in their entireties.

### BACKGROUND

Traditional news organizations employ a centralized approach where a single entity investigates, verifies, curates, and distributes news based on its perception of what the public wants. While this model may be effective in providing global or national news, the amount of resources required to report news in this manner makes it costly and inefficient to implement in local markets. Therefore, the traditional news distribution paradigm may be inefficient in, for example, providing relevant local content to some markets.

Moreover, existing user-generated content sources and other related social media platforms employ little to no hierarchical organization of the data housed within their systems. This makes navigating the data within these systems challenging and cumbersome.

### SUMMARY

In view of these shortcomings, it would be advantageous to provide an improved mechanism for the sourcing, processing, and distributing of news content.

Disclosed herein are system, method, and computer program product embodiments for sourcing, processing, and distributing information in general, and more specifically, information that is generally news or news-related in nature. An embodiment operates by determining a geographic area and selecting stories associated with the geographic area. The embodiment further generates map display information for the geographic area. The map display information also includes a plurality of selectable indicators, each corresponding to one of the one or more stories, and transmits the map display information to an interactive user device.

### BRIEF DESCRIPTION OF THE DRAWINGS

The accompanying drawings are incorporated herein and form a part of the specification.

FIG. 1 is a high level process flow diagram of a crowdsourced news process environment, according to an example embodiment.

FIG. 2 is a block diagram showing details of a crowdsourced news processing environment for receiving, organizing, and distributing news reports, according to an example embodiment.

FIG. 3 is a block diagram showing details of a data organization module, according to an example embodiment.

FIG. 4 shows a dual axis timeline (DAT) for navigating a plurality of news events and reports, according to an example embodiment.

FIG. 5A is a flow chart of a method of creating stories in a DAT structure from a plurality of reports, according to an example embodiment.

FIG. 5B is a flow chart of another example method of creating stories in a DAT structure from a plurality of reports, according to an example embodiment.

FIG. 6 shows a map interface for a user to interact with news content, according to an example embodiment.

FIG. 7A shows a map user interface with selectable graphical elements, according to an example embodiment.

FIG. 7B shows a map user interface using a “balloon logic” method of representing selectable graphical elements, according to an example embodiment.

FIG. 8 shows a graphical user interface (GUI) for displaying a grid story browser, according to an example embodiment.

FIG. 9 shows a GUI for displaying a story detail browser, according to an example embodiment.

FIG. 10 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for sourcing, processing, and distributing information in general, and more specifically, information that is generally news or news-related in nature.

### System Overview

Embodiments are directed towards a system that receives crowdsourced information, processes the information, and delivers the relevant information to information consumers. While the following description uses sourcing and distribution of highly relevant news and news-related content to the end consumer as an example, embodiments are not meant to be so limited.

Embodiments may include crowdsourced content, whereby citizen journalists record and submit information reports to a news processing system. The system may then programmatically process these reports by organizing and aggregating related ones into a single story. In an embodiment, the system may automate aggregation and organization of the reports. The reports may be displayed on a user interface (UI). In an embodiment, the reports are displayed on a map-based user interface that displays news story indicia on a map according to their location of occurrence. In an embodiment, a user interface contains various tools with which users can adjust various parameters of the content they want to consume, and the system can then deliver content based on these parameters.

Contrasted against traditional news gathering techniques, crowdsourcing news through electronic devices offers significant advantages. For example, the number of potential reporters that may be participating in this system is far greater than the number employed by a traditional news organization, so the system scales as needed across localities. The implication of this is that the breadth of coverage may be far greater than that of a traditional news organization, yielding faster and more comprehensive primary access to news events as they occur. In this manner, a crowdsourced news processing system may allow news to be reported in real-time, or near real-time. Further, crowdsourcing news may facilitate the recording of information and news reports from a variety of unique or differing perspectives. This may contribute to greater depth of coverage through multiple reports of the same information from different vantage points. The system output may be a report comprised of many different subjective viewpoints, contrasted against traditional news organizations attempts at one, objective viewpoint.

### Crowdsourcing

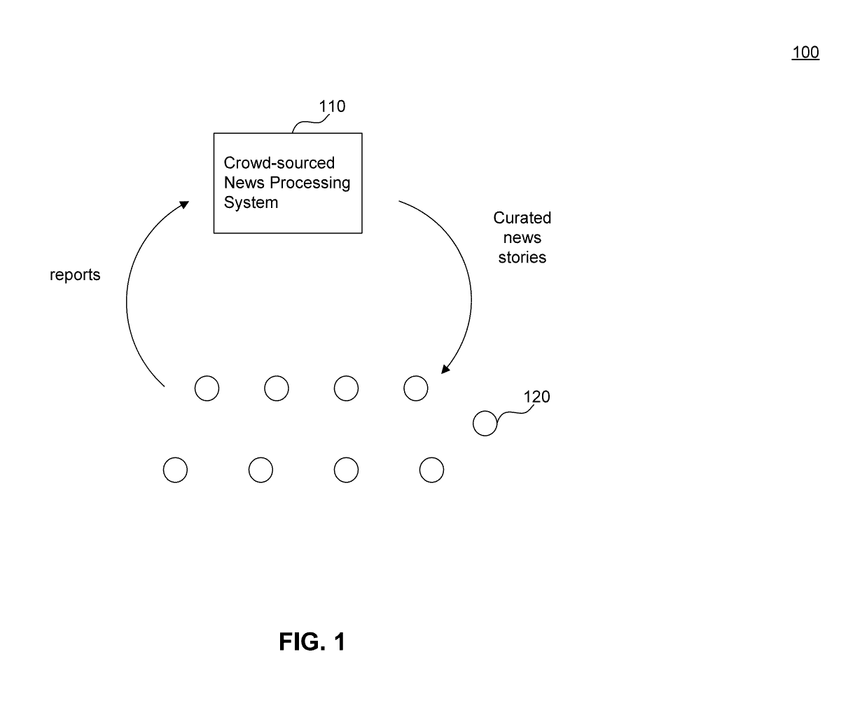

FIG. 1 is a high level process flow diagram of a crowdsourced news processing environment 100, according to an example embodiment. In an embodiment, crowdsourced news processing environment 100 contains a crowdsourced news processing system 110 and a plurality of user devices 120.

Generally, crowdsourcing may include a distributed network of individuals participating in a specific activity on an ad hoc basis towards a common goal or task. Crowdsourced news processing system 110 may employ crowdsourcing to source reports of news events and other news-related information. For example, a proprietary network of citizen journalists may contribute reports of news through their smartphone or other similar electronic device. These events could be events they witnessed and had primary exposure to, but they could also be events they became aware of through other means.

A user of a user device 120 may report on an event that they witnessed by submitting a report through an user interface to crowdsourced news processing system 110. A report may include, for example: a photo or video, a text description of an event, a topical categorization of the report which a user selects from a predefined set of choices, etc. The report may also contain the user's current location, time of submission, identity of the user device, and identity of the user submitting the report. In an embodiment, the user can enter a location and time of an event, which may be different from the current location and time of submission.

Crowdsourced news processing system 110 may filter, curate, and organize the reports for news distribution to user devices 120. User devices 120 may receive curated news reports from crowdsourced news processing system 110 based on various criteria, such as, for example, location, popularity, importance, user preference, etc.

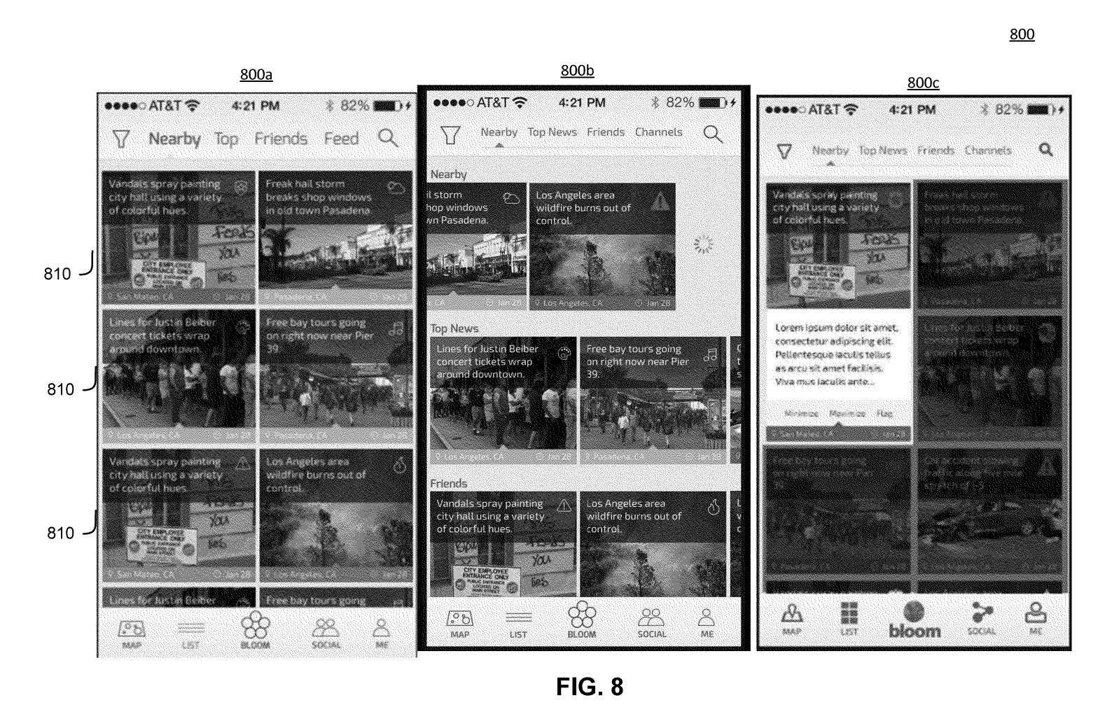

Crowdsourced news processing system 110 and user devices 120 may be implemented using one or more computer processing devices, such as, for example, those described with reference to FIG. 8 below. In an embodiment, crowdsourced news processing system 110 is implemented using one or more computer servers, and user devices 120 are personal computing devices, such as, for example, personal computers, mobile devices, tablets, laptops, smartphones, etc. System 110 and user devices 120 may communicate via wired or wireless means across a communications network, such as, for example, a local area network (LAN), a wide area network (WAN), the Internet, etc.

### Programmatic News Processing

Crowdsourced news processing system 110 may employ an algorithmic approach to news processing. System 110 may perform a series of discrete but related activities on incoming reports as they are submitted. These activities as a whole may organize the submitted reports into a hierarchical system that forms the basis for what and how the information is displayed to the users once processed. In an embodiment, the overarching goal of the system and the user interface is to provide the most important information or reports occurring at a specific location or region (a “geozone”) by creating, reporting, display, etc., news stories. News stories may include a grouping of various news reports describing a sequence of related events. That is, as different users send in reports on the same event, or as users send in reports on related events at different times, a news story may be generated by collecting and organizing all of the related reports.

To organize the reports in this manner, the system may address, for example and without limitation, the following challenges and questions:
Is a particular report unlikely to be genuine for any reason?
Which reports are related, and should they be aggregated into a new or existing news story?
If a report should be aggregated into an existing story, does this new aggregated event represent a temporal or topical update to the story, or is it another detail or perspective on a concept that has already been included in this story?
How important is this report?
How long should this report/story remain active?

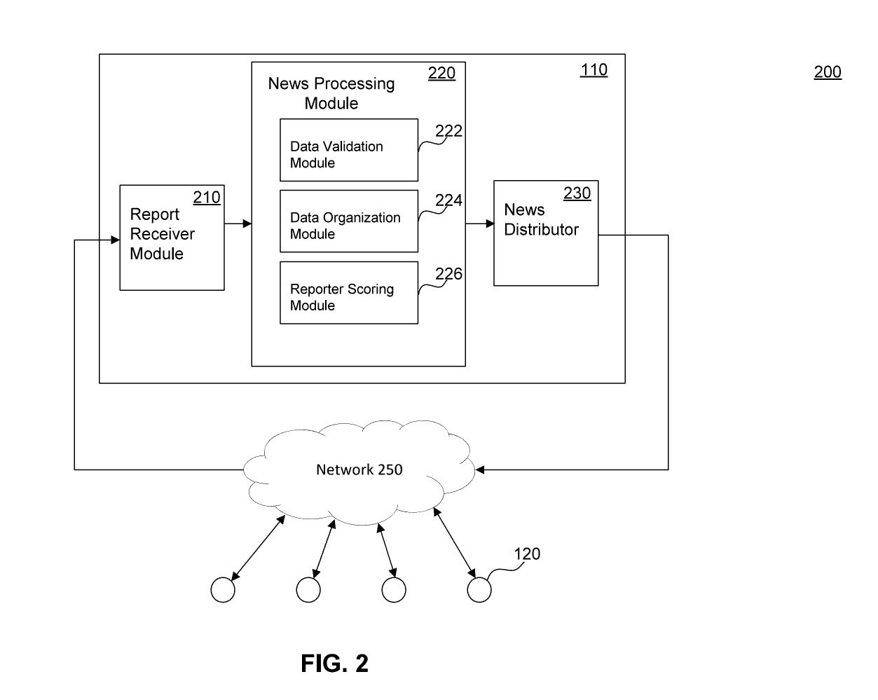

FIG. 2 is a block diagram showing details of a crowdsourced news processing environment 200 for receiving, organizing, and distributing news reports, according to an example embodiment.

The crowdsourced news processing environment 200 may contain news processing system 110 in communication with user devices 120 through a network 250.

Network 250 may be any data communications network, or combination of data communications networks, wired and/or wireless, configured to transmit data between devices. By way of example and not limitation, network 250 may be a local area network (LAN), wide area network (WAN), the Internet, etc.

In the embodiment of FIG. 2, news processing system 110 contains a report receiver module 210, a news processing module 220, and a news distributor 230.

Report receiver 210 communicates with user devices 120 through network 250 to receive reports.

News processing module 220 receives reports from report receiver module 210. News processing module 220 filters and organizes the submitted reports into a hierarchical system of news stories.

News distributor 230 receives the organized news stories from news processing module 220. News distributor 230 communicates with user devices 120 to distribute the organized news stories to user devices 120.

In an embodiment, news processing module 220 includes a data validation module 222, a data organization module 224, and a reporter scoring module 226.

### Data Validation

Data validation module 222 evaluates and analyzes the information contained in a report to determine whether there are any internal inconsistencies with the submission. The analysis may include information that the user has provided, for example and without limitation: a picture/video, a text description of the event, a time of the event (if supplied by the user), a location of the event (if supplied by the user), and a topical category for the event. The analysis may also include information that a user device 120 has passively collected, for example and without limitation: the time of submission, the time the picture/video was taken, the location of submission, the location the picture/video was taken, or the identity of the user and device.

In an embodiment, data validation module 222 may be configured to act optimistically by, for example, accepting reports as genuine by default. In another embodiment, a report is analyzed, and if the quality of the report drops below a quality threshold imposed by the system, the report is taken down. Data validation module 222 may evaluate pieces of information in the report to detect one or more potential indicators of inauthenticity. Some examples of inauthenticity indicators include but are not limited to: miscategorization of a report, a text description that does not match the picture or video submission, significant differences between the user generated time or location and the time or location of the report submissions, etc.

### Hierarchical Data Organization

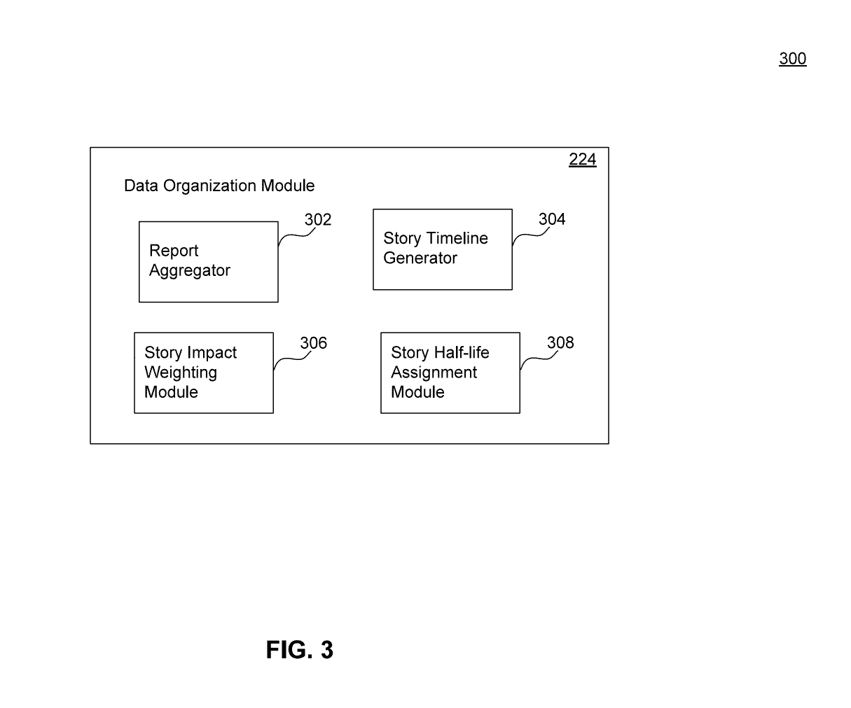

Data organization module 224 may organize the data into temporal and importance hierarchies. FIG. 3 is a block diagram showing details of data organization module 224, according to an example embodiment. In the embodiment of FIG. 3, data organization module 224 includes a report aggregator 302, a story timeline generator 304, a story impact weighing module 306, and a story half-life assignment module 308.

Report aggregator 302 may combine related, similar, or redundant reports into a single story. The story houses a plurality of events. Aggregation may allow users to interact with a much broader data set than is typically available from a traditional news source, while still benefitting from content curation and organization. Aggregating reports may also reduce redundancy within the system and reduce distractive elements that are not additive to the corpus of information. In an embodiment, report aggregator 302 generates a similarity score between pairs of reports, and aggregates reports when their similarity exceeds a threshold. Report aggregator 302 may use one or more of the following techniques to perform aggregation:
Geospatial/temporal filtering: aggregator 302 may initially sort and group by time and location, which establishes candidates for potential aggregation.
Natural language processing (NLP): aggregator 302 may conduct natural language processing on the text submissions in the reports and compare the text submissions for similarities.
Video/image processing: aggregator 302 may convert the media contents of a report submission (pictures or video) into text, and then employ NLP to compare the similarities of the media contents to other reports.
Joint text/image processing: once event aggregator 302 converts the media contents to text, the text can be compared against the text and media submission of other reports.
Machine learning: over time, aggregator 302 may employ supervised or unsupervised machine learning processes to improve aggregation, for example, by calibrating the similarity thresholds for report aggregation.

In an embodiment, report aggregator 302 continuously performs aggregation on all new report submissions. In an embodiment, aggregation can be divided into two discrete functions, 1) report cluster creation and 2) integration into existing report clusters. First, report aggregator 302 can create clusters of related reports from previously disaggregated reports. A report cluster may also be called a story, and may be created from geospatial, temporal, and contextual data found in the reports. Once report clusters have been generated, aggregator 302 may evaluate new reports as they are submitted as candidates to be included in the existing clusters. Evaluating a new report for integrating into existing clusters may reduce the number of comparisons required for aggregation and improve efficiency. Organizing reports into geospatial/temporal cohorts may reduce the number of reports on which the contextual analyses must be executed. This may enhance the speed of the system, and reduces the computational cycles that would otherwise need to be utilized if these contextual analyses were performed on and against every report submission.

Report aggregator 302 may organize related reports in a story in a variety of arrangements. For example, in an embodiment, report aggregator 302 organizes a story along a generalized dual axis timeline

### Generalized Dual Axis Timeline

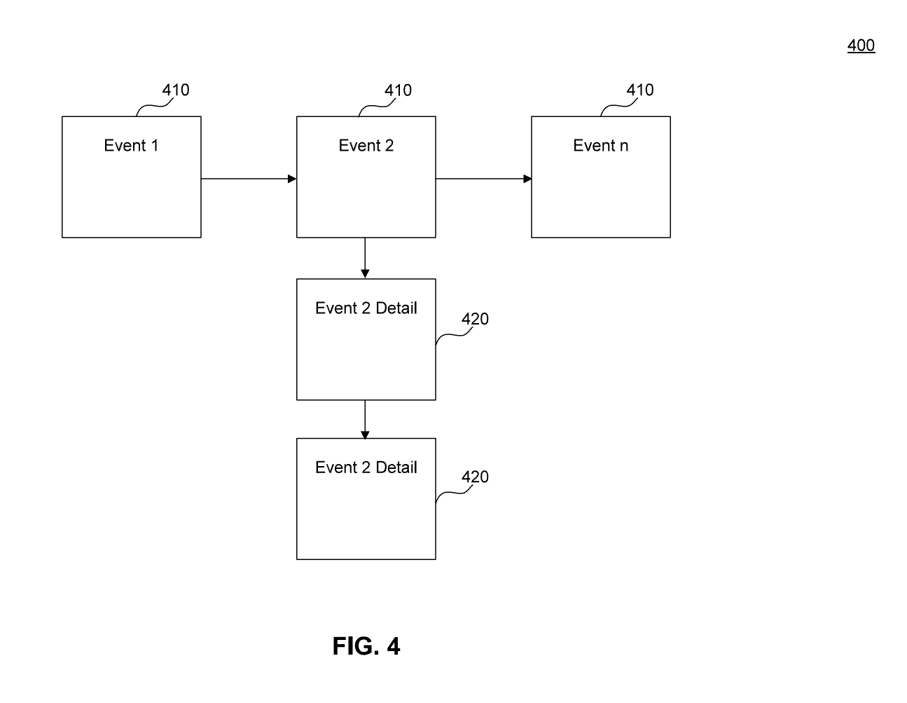

FIG. 4 shows a dual axis timeline 400 for navigating a plurality of news events and reports, according to an example embodiment.

Dual Axis Timeline (DAT) 400 is a structure that includes a first and a second axis. The first axis represents a higher order parameter that dictates the content provided in the second axis. In an embodiment, the first axis extends along the X direction, and the second axis falls beneath along the Y direction. Generally speaking, timeline 400 can be used to capture breadth and depth across two axes. This could apply to recipes and ingredients, types of animals and all the sub-types that fall under the broader grouping, or any other ordered structure. The DAT structure will be explained herein using the explicit example of news stories.

Related reports that have been aggregated into reports clusters, as previously explained, can be further organized into a DAT 400. This allows a user to intuitively navigate to the most relevant content within a news story. The DAT 400 structure may allow users to understand the genesis of a story through a series of major temporal/topical events. A relatively limited number of these major events may make up the story, and the DAT organization can allow a user to quickly gain a high level of understanding about this story. The DAT 400 structure can also help a user find in-depth coverage by drilling down into the details of any particular major event to get the benefit of multiple viewpoints, perspectives, or biases around the story or event.

In an embodiment, DAT 400 describes a news story. DAT 400 can include horizontally-positioned events 410 and vertically-positioned event details (or sub-events) 420. The horizontal events 410 represent a topical or temporal timeline, and the vertical/columnar event details represent the details or perspectives timeline, however the utility or functionality of the DAT is not limited to this horizontal and vertical orientation. Events and sub-events can include individual user-submitted reports, or consolidations or summaries of user-submitted reports. The organization of the data into vertically organized topic columns allows a user to indulge in the details that they care about, and skip over that which they do not.

As an illustrative example, assume that a theoretical news incident occurs, such as an apartment fire, and the news incident is being reported by users. The story of an apartment fire may be divided into several events that occur within the major story of the fire. These events may be: 1) discovery of the fire, 2) emergency response to the fire, and 3) conclusion of the fire and post-mortem investigation. These three events may be identified through the report aggregation mechanisms explained above, and once identified they may be represented in each of the three horizontal nodes. Further, let's assume that there were 300 reports about this event in total, and that these posts were evenly distributed across the three temporal events. Each temporal event node would include the 100 sub-event detail nodes that would exist in the corresponding vertical columnar structure. In an embodiment, a user, through a user interface, can swipe horizontally through the horizontal nodes to acquire a general understanding of an event. If the user wants to dive into the details of a particular topic or concept represented by one of the events, the user can swipe vertically to drill down into the sub-event details.

In an embodiment, the horizontal elements of the DAT are organized temporally, while the vertical elements of the DAT are organized by popularity or importance. For example, whichever submission within a particular sub-event node best represents the main event (as determined by, for example, user activity) may be displayed first, as opposed to the submission that was submitted first or last.

### Event Sequencing

Once an aggregation task has been completed, the system may contain one or more report clusters. Returning to FIG. 3, story timeline generator 304 may take the relatively unordered nature of these report clusters and place them into the DAT 400 structure previously described, in order to form organized news stories. A story may be a collection of related, similar, or redundant reports that correspond or tie back to one or more event(s).

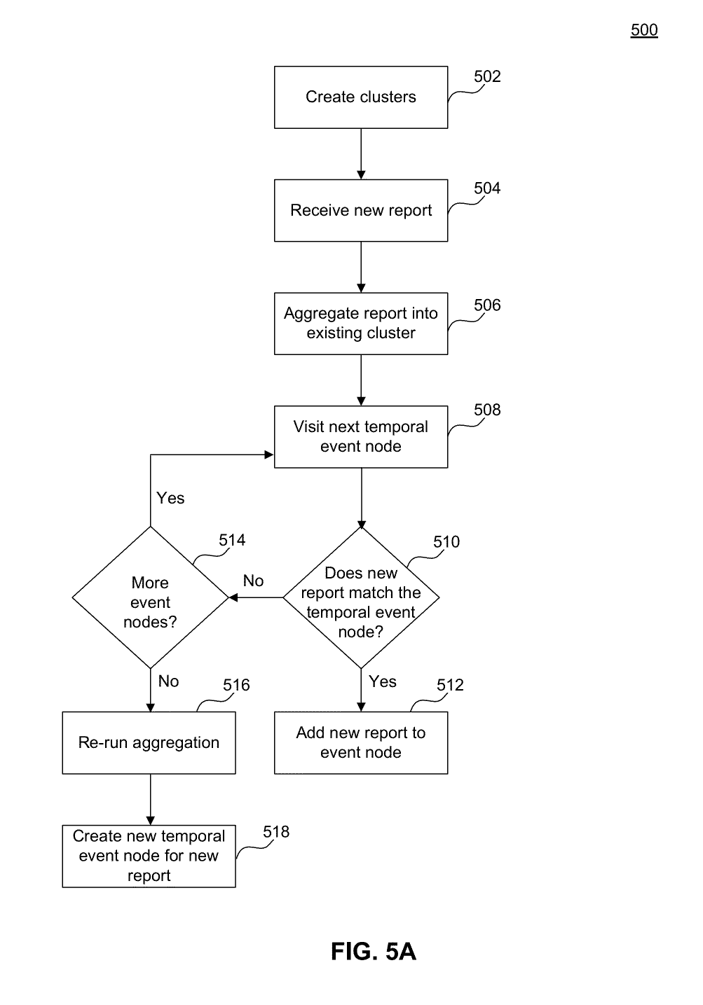

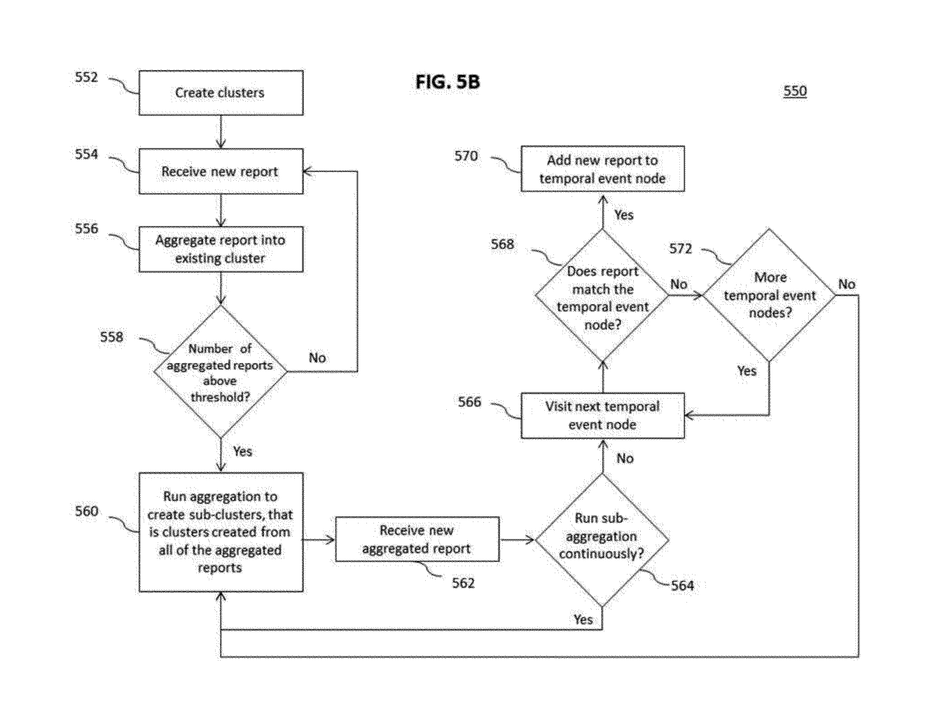

FIG. 5A is a flow chart of one example method 500 for creating stories in a DAT structure from a plurality of reports, according to an example embodiment. This method is but one way to create stories in a DAT structure from a plurality of reports, and the system may utilize other methods in conjunction with or in place of the method described in FIG. 5A.

At step 502, a temporal sequence of event nodes is populated from a report cluster by, for example, timeline generator 304. As explained above, report aggregator 302 creates clusters of from related reports based on a similarity score. Within a cluster, reports may be sequenced temporally. In an embodiment, the reports are divided based on aggregation within the cluster, for example, by dividing them into time segments, or topical categories. These divisions may form temporal event nodes. Multiple event nodes may create a backbone for the story structure, e.g., a sequence of events. The reports associated with an event may be organized in the vertical/detailed columnar data structures as supporting sequences of event details.

In an embodiment, event sequencing takes place as the event develops and new report submissions come in. At step 504, a new report is received by, for example, timeline generator 304. At step 506, based on report aggregation as described above, it is determined that the report should be aggregated into an existing cluster. This determination may be made, for example, by timeline generator 304.

Timeline generator 304 can determine where the report fits into the DAT structure by traversing the events by time sequence. In an embodiment, timeline generator 304 visits the temporal nodes in reverse chronological order. At step 508, the last node in the DAT structure is visited.

At step 510, new report submissions are compared against the visited node by, for example, timeline generator 304. If the report matches the temporal node, the report is added to the node's vertical/detailed data structure, as shown in step 512.

The comparison at step 510 may utilize one or more of the following tasks, which may be programmatically similar to those used in the initial event aggregation: geospatial/temporal comparison, NLP, media comparison, joint text/media processing, and machine learning. While components of the algorithm may be similar to those employed in event aggregation, the calibration of the sequencing algorithm may be different. For example, time and location may be relatively less important in this algorithm given the fact it may already have been established that these submissions are occurring at or near the same event around the same time. Furthermore, given the frequency of social media submissions, this algorithm may not be reliant on temporal nuances to determine order within an event cluster. That is, the signal to noise ratio for time of submission may be very poor.

If it is determined at step 510 that the report does not match the visited node, a decision is made whether there are additional nodes to visit, as shown in step 514. If so, the method returns to step 508 and the next temporal event node is visited.

If it is determined at step 514 that there are no more temporal event nodes, the aggregation score is re-run by, for example, report aggregator 302, to confirm that the report should be part of the aggregated cluster, as shown in step 516. If the report is confirmed to part of the aggregated event cluster, a new temporal event node is created for the new report, and the new report becomes a new temporal node, as shown in step 518.

FIG. 5B details another example embodiment for creating stories in the DAT structure. FIG. 5B is a flow chart for a method 550 that may be used to create stories in a DAT structure from a plurality of reports after a predetermined number of reports have been aggregated into an event, according to an example embodiment.

In this embodiment, the initiation of the creation of the story timeline happens retrospectively based on multiple reports, instead of as reports are submitted. In an embodiment, the method is performed after a predetermined number of events have been aggregated.

In method 550, initially all events are aggregated and bucketed into clusters at steps 552, 554, and 556, as they are in method 500. At step 558, for a given cluster, the system may determine a threshold of aggregated submissions before proceeding to generate a timeline for the cluster. In an embodiment, the threshold may be determined by the number of reports (i.e., size of the corpus of data) that yield an effective story detection. In an embodiment, the system may experimentally determine the level of reports that must be aggregated to indicate that this is an incident of importance. Other metrics or information may be used to determine this threshold as well. At step 558, the system checks to see if this threshold has been reached, and if so the method will continue. Otherwise, the system moves to step 554 to continue to aggregate reports. Until said threshold is reached, all aggregated reports in the cluster will populate a single horizontal node's vertical timeline axis of a DAT associated with the cluster.

At step 560, once the threshold has been achieved, a sub-aggregation process can occur whereby the reports with the most similarity can be grouped together into events. The comparisons at step 560 may utilize one or more of the following tasks, which may be programmatically similar to those used in the initial event aggregation: geospatial/temporal comparison, NLP, media comparison, joint text/media processing, and machine learning. While components of the algorithm may be similar to those employed in report aggregation, the calibration of the sequencing algorithm may be different. For example, NLP may be relatively more important in this step to understand nuances of the sub-categorization of events.

Once step 560 is initiated, new reports may come in and get aggregated into the cluster, as shown in step 562. In an embodiment, the system can be configured to continuously perform the sub-aggregation of reports, as shown in steps 564 moving to 560.

Alternatively, the system may also be configured to aggregate new reports into the existing DAT structure, as shown in steps 566, 568, and 570. In this scenario, the system may determine whether a new report can be aggregated into one of the existing DAT events, as shown in step 568. If the new event submission is not aggregated into any of the existing DAT event nodes, as shown in step 572, the sub-aggregation process in step 560 may be repeated. This sub-aggregation process may also be periodically run to update and refresh the DAT structure, which may result in a reorganization of events in the DAT structure.

### Story Impact Weighting

Returning to FIG. 3, story impact weighting module 306 may be used to determine the relativistic importance of stories within the system. Aggregating, sequencing, and organizing reports sequencing into clusters and stories establishes functional units within the system. In an embodiment, weighting module 306 further organizes these stories relative to one another.

This process may employ two distinct methodologies, which in combination may establish a relative importance between clusters. First, feedback from user interaction with different stories can be used to score stories. Second, methodologies to predict the importance of an event independent of user interaction can also be used to score stories.

User interaction with events may provide measureable feedback on the importance of an event. A user can interact with a story in a number of ways, detailed further below in the description of the user interface. By way of example and not limitation, the user may interact with a story in the following ways:

Previewing a story: user selection of a story may open a preview of the story. The preview may provide more information than previously displayed in an user interface, but less than all the information on the story or its DAT structure. Previewing a story may be considered positive feedback for the story. From the preview, the user may choose to view the full story detail, or may close out of the story preview. The former may be considered another piece of positive feedback, while the latter may be considered a negative piece of feedback.

Viewing a story: Again, weighting module 306 may consider a user opting to view the entire story detail as positive feedback. Once within the story, there may be other ways in which a user can interact with the event.

Sharing a story: a user may elect to share a story, for example, within the user's social graph. Weighting module 306 may consider sharing as a positive feedback for this story. In an embodiment, sharing a story may be a stronger piece of positive feedback than viewing a story.

Updating a story: once within the story, a user can share more information on the story by adding a new report to the DAT structure. Weighting module 306 may consider the new addition as another piece of positive feedback for the story.

Flagging an event: users may flag stories if they feel they are inappropriate or inaccurate for any reason. This may be considered a negative piece of feedback for the story. By flagging a story, the user may also trigger a human review of the story, which can lead to the ultimate removal of the story from display.

Story views, shares, and updates may be recorded and accordingly used to rank the story's importance as a function of absolute number of contributions within each category of interaction, which can also be referred to as the story's magnitude. Moreover, the rank may also be based as a function of the speed of these contributions. For example, a story which receives 100 views over the course of a week is relatively less important than a story which receives 100 views over a five minute period of time.

For example, a story's magnitude score may continually change based on the inputs from user activity. In an embodiment, the slope of the activity may be useful in differentiating the magnitudes of stories. On an X/Y axis, if X is the temporal axis and Y is the magnitude of the metric of consideration, which for the sake of example here is user views (but could be any other generalized activity metric), then the slope of the curve plotted over time is the acceleration (or deceleration) of activity. To illustrate, at a given point in time, if two events have identical user contribution statistics it could be argued that they should have the same magnitude weight. However, if Event A has substantially the same user metrics over the course of the last several hours, and Event B has been doubling every 30 minutes since first reported two hours ago, Event B may be considered relatively more important within this system. Just as events grow as their contribution grows, they may shrink as their contribution shrinks.

In addition to user interaction, methodologies to predict the importance of an event independent of user interaction can also be used to score stories.

User feedback for events may be very valuable for ascertaining the relative importance of stories. However, if the stories within the system are displayed based on hierarchy, nascent stories which have little or no activity may be subject to an activity bias in that they will not have the same level of opportunity for user interaction. As such, there may be a need for a mechanism to elevate nascent stories to give them the opportunity for interaction.

Simply elevating stories to some arbitrary high level of importance may introduce a new bias whereby new stories may take precedence over older stories, independent of the content. However, artificially elevating the relative importance may still be employed in two ways: A) contextual analysis, and B) activity curve analysis. In the first approach, weighting module 306 can analyze and determine a topic or archetype of a story, and deduct from the analysis an expected activity curve. In the second approach, weighting module 306 can compare an activity curve of the subject event against a database of historical or other activity (e.g., story growth) curves to see if there are any similarities or matches. If a match has been established, weighting module 306 may deduce the expected future activity.

Contextual analysis: As explained above, by employing picture/video image processing in combination with natural language processing, weighting module 306 may identify what a report or story is “about”. This process may be applied to a single report on its own, and to the extent it is part of a story, it may also be applied to all the reports that reside within the story. Once the topic of the story is determined, this can be compared against the activity curves of similar story archetypes, or against another database or key which can provide the expected activity levels by story topic or archetype to anticipate what the subject story's potential activity would look like. The universe of potential model stories can further be refined based on other attributes or parameters of the story, which could include but are not limited to, when and where the event happened.

Activity curve analysis: while contextual analysis may be an accurate way to predict a story's future, at times the topic of a story may be unclear, and it may be more accurate to analyze the activity of a story rather than the story information itself. In this analysis, the activity curve of a subject story is superimposed on historical data of past stories. Since stories may tend to grow and decay with some repeatability, finding a story with similar growth characteristics can provide insight into the future of the subject story.

In an embodiment, contextual analysis and activity curve analysis are employed in concert. Understanding the archetype of a story may be an indicator of how popular or important a story should be. The activity of a story may be a function of the subject matter of the story, along with other factors. However, given the various other factors that can impact a story (when it happened, where it happened, what else was happening when it happened, how many users were active in the system when it happened, etc.), activity data can be useful to further refine the predicted magnitude of the event.

Once a predictive activity curve has been selected for the subject event, weighting module 306 may essentially “fast-forward” the subject event along the curve, elevating it to an expected level at some point in the future. In an embodiment, the story may be ascended to a level through machine learning and calibration, which may be high enough for the event to have enough momentum to realize its expected steady-state magnitude.

### Event Half-Life

The half-life of an event within the system may be important as well. News distributor 230 may deliver current events, and this may require the information in the system to remain current and not go stale. To address this, story half-life generator 308 may assign half-lives to stories. The half-lives may be based on story archetypes, which include the event subject matter and the relative importance. In an embodiment, story half-life generator 308 may apply an automatic decay function to the magnitude of the event as a mechanism for accelerating the organic decay, which is a function of the story impact weighting module 306. This decay feature may take effect once the event has achieved a steady-state of activity for a certain period of time determined through machine learning and calibration and based on the weight assigned from 306, or as a function of the commencement of organic decay, etc.

### Reporter Scoring

Reporter scoring is a separate but related topic to all the programmatic processes that are utilized in the processing of report submissions. Reporter scoring module 226 may create a system of both encouragement for users to contribute and also a system of responsibility within news processing system 110.

As mentioned previously, news processing system 110 and data validation module 222 may act optimistically, whereby an event is posted without requirement of authentication or corroboration. Similarly, users may, by default, have the ability to report on events. From that state, reporter scoring module 226 may monitor their contributory activity. Users can earn additional privileges or features within news processing system 110 by posting frequently or by posting content that garners a lot of activity. If a user chooses not to post, posts infrequently, or posts content that is not particularly interesting, that user may be denied the ability to receive or unlock additional features or privileges. If a user posts content that is inaccurate, objectionable, or deemed to be malicious in nature, that user may be warned, censured, and subject to a loss of privileges.

In this manner, reporter scoring module 226 may provide a way in which to encourage constructive user behavior and establish a relative ranking system among the citizen journalist users.

### Distribution and User-Directed Consumption

News processing system 110 may employ a user-directed approach to news consumption. Editorial-based journalistic institutions generally tend to focus their energy on the curation of news stories in an attempt to cull the most relevant news content for their user base. System 110 may take an approach whereby news distributor 230 provides the user with a tool set with which to interact with all of the content housed within the system and discover the content that is most relevant to them. System 110 may also take user feedback (such as statistics related to news sharing, interest indicators, number of reads, etc.) into account in determining what news stories are relevant to users. Thus, news distributor 230 may provide a highly customizable, tailored experience that may be different for every user. Further, the news distribution may be dynamic, allowing the user to change their preferences or interests at any point in time. This reflects the possibility that a single user may also have different needs and interests depending on their situation or use case.

### Map User Interface

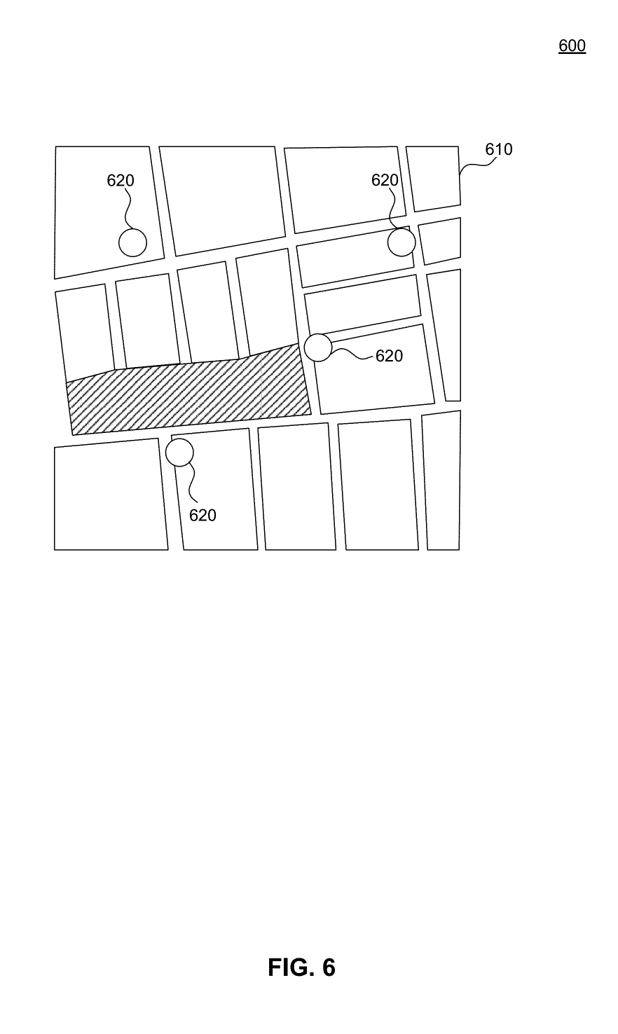

FIG. 6 shows a map interface 600 for a user to interact with news content, according to an example embodiment. Map interface 600 includes an interactive map 610 and one or more user-selectable story indicators 620. Map 610 may be a dynamic mapping interface that displays news content represented by story indicators 620. User-selectable story indicators 620 may be, for example, color coded circles on the map that users may select to access a story. In an embodiment, indicators 620 are color coded to indicate super-categories (e.g., danger, culture, etc.), and may further have an icon to denote the specific sub-category (e.g., crime, emergency, etc.). The indicators may also be sized differently from one another to illustrate the relative importance of the stories that are displayed on the map. Map interface 600 may include user interface options for filtering stories by sub-category, and for searching keywords or topics of interest within the map.

Through map interface 600, which displays geographic-based content, users may explore, search for, and access news content in a more efficacious fashion through a variety of different utilizations. There may be three primary use cases for how users will explore the geographic content: when a user is generally exploring news in an area, when a user is exploring news in an area by a specific parameter (e.g., topic category, author, etc.), or when a user is looking for information on a specific event. Users may explore what is going on around them (or at any other geographic area) in a general fashion to learn about news relevant to a particular geography in a general sense. For example, a user may be looking to catch up on the news in their neighborhood that has occurred while they were traveling. A user may also use the geographic-based approach to search for highly specific news through a variety of parameter filters, such as, for example, geographically and categorically tailored news. For example, a user may be able to find cultural news related to a particular neighborhood in Washington, D.C. Users may also specifically search for a story or event that they are aware of. For example, a user may be investigating why there is a smoke plume five miles east of their location.

In an embodiment, news distributor 230 displays a predetermined number of elements on map user interface 600 at any one time, irrespective of geography and zoom level. For example, map user interface 600 may display the top stories at the moment, based on relative importance. The top stories may be dynamically recalculated based on a map area selected, as well as any other parameters the user has input (e.g., filters, search, etc.). To illustrate, if a user who lives in a dense suburban neighborhood wanted information only on the street the user lives on, the area of interest may be very small and thus most reports may be displayed. If the user were to zoom out to a view that covered a 5 mile radius, then the content displayed may be more impactful in nature or relevant to the entire area, and some of the lower-impact events previously displayed in the small area of interest may no longer be displayed.

Thus, news distributor 230 may provide a mechanism to restrict the content displayed so as not to overwhelm a user. Also, news distributor 230 may allow users to search geographically, by interacting with map user interface 600. For example, if a user is looking at a map of the entire United States, map user interface 600 may display national news. If users are looking at a map of their local town, map user interface 600 may display general local news.

In an embodiment, map interface 600 can utilize a social networking graph and topic feeds subscriptions to filter news content on the map. For example, a user may be part of a social network, such as Facebook™, Twitter™, Instagram™, LinkedIn™, etc. In an embodiment, news processing system 110 provides its own social networking functionality to connect users 120 with each other. Map interface 600 may use social networking connections to provide news by, for example, allowing a user the option to display news stories that have been shared or liked by other members of the user's social network.

### Dynamic Repositioning of Map Elements—“Balloon Logic”

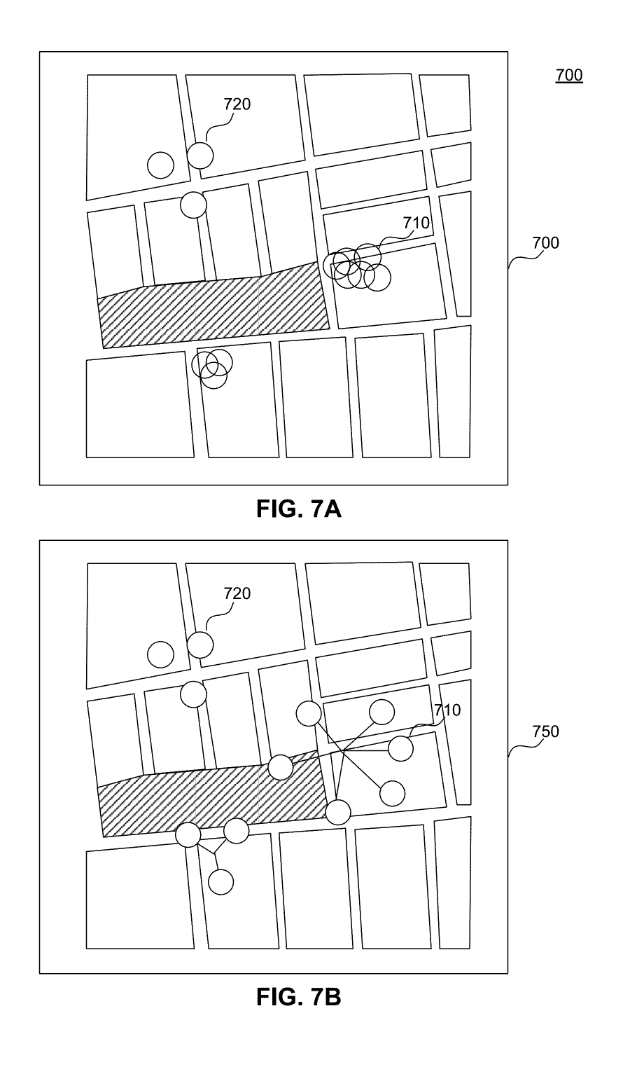

FIG. 7A is a map user interface 700 with selectable graphical elements 710, according to an example embodiment. Within a mapping interface, two elements 710 may exist at or near the same location, and thus may overlap when displayed. Given that these elements are generally represented by an icon, pin, dot, or other graphical element that takes up some modicum of space, there is the potential that one element could obscure another element. In map areas with a high density of elements, it can become difficult to view or select any individual element with accuracy.

Some map-based systems address this by using a clustering mechanism, whereby elements that would be obscuring each other are aggregated into a super-element. Further, these clusters are often clustered together again, resulting in clusters of clusters. To view any individual element, a user may drill down through each cluster until reaching a zoom level on the map that can accommodate all of the elements that exist within this zoom level, unobscured.

FIG. 7B depicts a map user interface 750 using a “balloon logic” method of representing elements 710, according to an embodiment. In an embodiment, news distributor 230 evaluates the elements on the screen to determine whether there are any elements 710 that overlap or obscure one another. If there are, the system applies a “balloon logic” method to rearrange the elements on the map. In an embodiment, “balloon logic” displays overlapping elements in a location adjacent to or within the element's intended location. As mentioned above, the number of elements displayed on the map interface at any one time may be capped at a predetermined number. “Balloon logic” may be modeled after the way balloons interact with one another when their strings are tied back to one location, such as a person's hand. By way of analogy, balloons do not occupy the space of another balloon, and dynamically move around one another to occupy spaces that are close to the origin (a person's hand), but not in the location of another balloon. If one were to view a group of balloons from an aerial, bird's eye view perspective, all of the balloons may be visible and accessible to the view (assuming there is only one planar layer of balloons, as with the elements on a map).

Similar logic may be applied to the elements in the map. If a map element is overlapping or obscuring another element, the elements may be moved away from one another to avoid overlapping. In an embodiment, when an element is moved from its origin, a line is drawn from the element to its origin to indicate where it originated. A user can then individually select elements in map interface 750.

Due to the location based nature of elements on the map, it may be desirable to keep the location of the elements displayed on the map close to their original location. In interface 700, elements 720 do not overlap and do not need to be repositioned. In interface 750, elements 720 reside at the same location as they did in interface 700 since the balloon logic was not applied to them. Further, for elements 710 which were repositioned after the application of balloon logic, they may be repositioned to be as close to their original location as practical to maintain the integrity of the map interface.

### Parameter Based Search and Display—Mechanism and Interface

News processing system 110 may employ a mechanism for a user to search and filter information or news content based on a variety of parameters. Existing user-directed systems may allow users to utilize a limited set of different parameters, which may mitigate a user's ability to find relevant content. In an embodiment, system 110 treats every potential parameter as a potential candidate for searching or filtering content. In an extension of the user directed approach described herein, a user may incorporate as many or as few (including none) of the parameters into the search or filtering exercise in combination with one another such that the information displayed in the results is entirely determined by the user.

These parameters may include, but are not limited to: topic of the news or information, source of the news or information, the type of content included in the news or information (e.g., text, audio, picture, video), the magnitude or impact of the news or information, the number of submissions on a particular topic of news or information, location of the origin of news or information, location(s) affected by the news or information, location of the user, time of occurrence of the news or information, duration that the news or information has been active in the system or the time elapsed since it first was submitted, author of the news or information, people involved in the news or information, people who have consumed the news or information (e.g., in one embodiment, a user may filter information or news content by restricting the results to content that has been consumed by someone they know or is part of their social network), the sentiment of the news or information (e.g., positive or negative), popularity of the news or information (either within an entire population or within a user's social network), or similarity of the news or information to past content consumed by a user.

In one embodiment, news distributor 230 may restrict the number of results of a user's filter or query to provide a digestible amount of content for the user to evaluate. This evaluation may allow the user to quickly adjust the parameters of the filter or query within news distributor 230 to receive new and improved results. In one embodiment, news distributor 230 may display these results in a list, or in a grid view, as described with reference to FIG. 8. In an embodiment, news distributor 230 may display these elements in map interface 600, as described with reference to FIG. 6.

The parameter based search mechanism may create a system of news or information layers within system 110. A news or information layer may be a combination of different parameters to create a restricted set of results that are displayed to a user. While the contents of a news or information layer may be displayed in a variety of fashions, including but not limited to a list, grid, or map interface, in one embodiment the contents of a news or information layer may be displayed on map interface 600. To illustrate the mechanics of a news or information layer by way of example, a user may be searching for news within a one mile radius of her current location, and would like to see the most impactful news displayed. The user may zoom in closer on her location thereby restricting the geography, and may receive a different set of news events since she has now accessed a new “layer” that is more local in nature. The user may then filter the news events by a topic category, and may receive a different set of news events since she has accessed another layer, which is at the same location but is restricted to her topic of interest. The user may then zoom out to view the entire world, and would see the most relevant events within her topic category of choice worldwide.

News or information layers and a parameter based search mechanism may aid a user in navigating large volumes of content. Further, the combination of the parameter based search mechanism in system 100 and news distributor 230 and the map interface 600 may provide a method for users to visualize information in a way that enhances their ability to process information and navigate to news or information of interest.

### Grid View

FIG. 8 shows a graphical user interface (GUI) 800 displaying a grid story browser, according to an example embodiment. GUI 800 provides a grid view for browsing news stories. The grid view may display news stories as tiles that are part of a matrix. The stories may be organized and displayed using filtering options as described above, including filtering by sub-category, search, and social filtering.

GUI 800 includes one or more lists of stories 810 lined up across one axis. In the embodiment of FIG. 8A, each list is displayed across a horizontal axis. Each list may include news associated with a category, for example, Nearby stories, Top News, or news shared or liked by Friends in a social network, as shown in the example screenshot 800a.

In an embodiment, when a user scrolls one of the lists of stories 810 to the side, GUI 800 loads additional news stories associated with the category, as shown in example screenshot 800b. In an embodiment, when a user clicks on one of the stories, GUI 800 displays additional details related to the story, as shown in GUI 800c. The additional details may include, for example, a short summary of the story, a location of the story, an options for maximizing into a full story detail page, etc.

### Social Consumption Tools

In an embodiment, users can opt to filter the news content within the map and the grid views based on social network information.

For example, news processing system 110 may provide social networking functionality for users to establish a network of friends. In an embodiment, the social network of system 110 uses a double-confirmation system where two users confirm their approval to establish a friendship. In an embodiment, the news layer hierarchy applied to content is based on the activity within the entire system 110 social network. Additionally, in an embodiment, a user applies a friends-based filter to shift the news layer hierarchy, and to filter based on data from their friend circle instead of that of the entire universe of users of system 110.

Subscriptions may follow a similar logic as well. A subscription may allow a user to follow a certain person or topic within system 110. In an embodiment, users are not required to be confirmed friends with this person and they can subscribe to anyone's content at will. As with the friend filter, the user may apply the subscriptions filter to refine the universe of content displayed, which becomes a function of the people and content contained within their subscriptions.

### Story Detail—Dual Axis Timeline

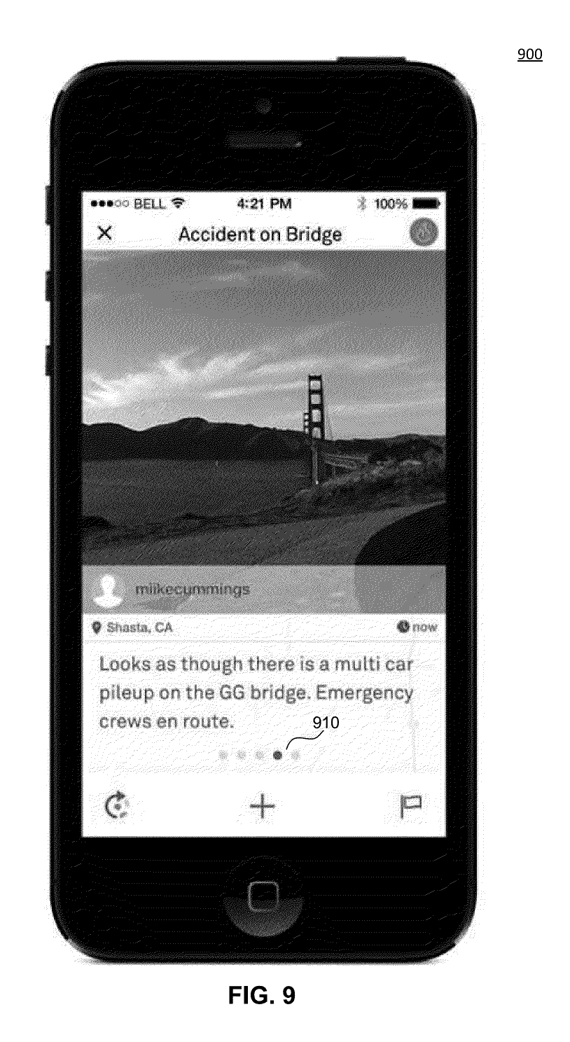

FIG. 9 shows a GUI 900 displaying a story detail browser, according to an example embodiment.

When a user selects a story, the user may drill down into the full detail of the story page. On this page the user may see the full header, text, photo/video, time and location of the story. This also becomes the users' portal to engage with the dual axis timeline for clustered reports, as previously discussed.

To interact with the dual axis timeline, the user may scroll through the grid to navigate the stories. In an embodiment, if the user wishes to engage with the horizontal/temporal updates to the timeline, the user swipes to the right to advance across the timeline, and to the left to go back. In an embodiment, a timeline indicator 910 lets the user know what position in the timeline the user is currently browsing. Once in any given temporal node, the user may swipe up to drill down into the corresponding associated elements with that node. In an embodiment, the actual nodal map of the DAT is not exposed to the user, but they can utilize visual indicators on the story detail page to navigate through the horizontal and vertical timelines.

### Story Abstract

In an embodiment, users can author additional reports that are of greater length and detail to sit on top of the DAT. The idea is that some concepts or explanations surrounding a story cannot be fully captured or expressed in the short form style of content that the reports utilize, and require a different format. In an embodiment, system 110 provides the abstract as a format that allows users to provide a more investigative, longer form description of a story or an event. In an embodiment, there is no limit to the number of abstracts that can be authored about a story, and anyone who has received access to authoring abstracts can do so. Abstracts may be associated with the corresponding story or report cluster, and be hierarchically organized in the same fashion as other reports.

### Sample Computer System

Each of the servers, user devices, and modules in FIGS. 1-3 may be implemented on the same or different computing devices in hardware, software, or any combination thereof. Such computing devices can include, but are not limited to, a server computer, a personal computer, a mobile device such as a mobile phone, workstation, embedded system, game console, television, set-top box, or any other computing device. Further, a computing device can include, but is not limited to, a device having a processor and memory, including a nontransitory memory, for executing and storing instructions. The memory may tangibly embody the data and program instructions. Software may include one or more applications and an operating system. Hardware can include, but is not limited to, a processor, memory, and graphical user interface display. The computing device may also have multiple processors and multiple shared or separate memory components. For example, the computing device may be a part of or the entirety of a clustered computing environment or server farm.

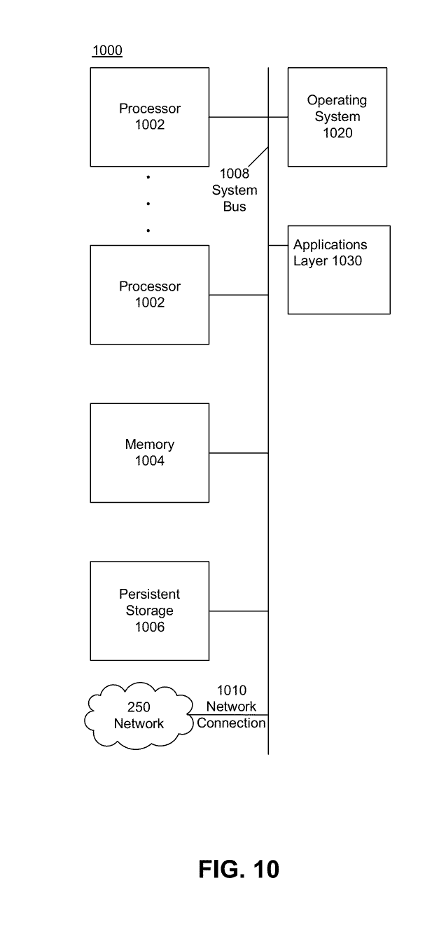

An example computing device is illustrated in FIG. 10. FIG. 10 is a diagram illustrating a computing device 1000 that accesses a network 250 over a network connection 1010 that provides computing device 1000 with telecommunications capabilities. Computing device 500 uses an operating system 1020 as software that manages hardware resources and coordinates the interface between hardware and software.

In an embodiment, computing device 1000 contains a combination of hardware, software, and firmware constituent parts that allow it to run an applications layer 1030. Computing device 1000, in embodiments, may be organized around a system bus 1008, but any type of infrastructure that allows the hardware infrastructure elements of computing device 1000 to communicate with and interact with each other may also be used.

Processing tasks in the embodiment of FIG. 10 are carried out by one or more processors 1002. However, it should be noted that various types of processing technology may be used here, including multi-core processors, multiple processors, or distributed processors. Additional specialized processing resources such as graphics, multimedia, or mathematical processing capabilities may also be used to aid in certain processing tasks. These processing resources may be hardware, software, or an appropriate combination thereof. For example, one or more of processors 1002 may be a graphics-processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

In order to manipulate data in accordance with embodiments describe herein, processors 1002 access a memory 1004 via system bus 1008. Memory 1004 is nontransitory memory, such as random access memory (RAM). Memory 1004 may include one or more levels of cache. Memory 1004 has stored therein control logic (i.e., computer software) and/or data. For data that needs to be stored more permanently, processors 1002 access persistent storage 1006 via system bus 1008. Persistent storage 1006 may include, for example, a hard disk drive and/or a removable storage device or drive. A removable storage drive may be an optical storage device, a compact disc drive, flash memory, a floppy disk drive, a magnetic tape drive, tape backup device, and/or any other storage device/drive.

Processors 1002, memory 1004, and persistent storage 1006 cooperate with operating system 1020 to provide basic functionality for computing device 1000. Operating system 1020 provides support functionality for applications layer 1030.

Network connection 1010 enables computer device 1000 to communicate and interact with any combination of remote devices, remote networks, remote entities, etc. For example, network connection 1010 may allow computer device 1000 to communicate with remote devices over network 250, which may be a wired and/or wireless network, and which may include any combination of LANs, WANs, the Internet, etc. Control logic and/or data may be transmitted to and from computer device 1000 via network connection 1010.

Applications layer 1030 may house various modules and components. For example, report receiver module 210, news processing module 220, data validation module 222, data organization module 224, reporter scoring module 226, and news distributor 230 may be included in applications layer 1030 when computing device 00 is used as news processing system 110.

It should be noted that computer-readable medium embodiments may include any physical medium which is capable of encoding instructions that may subsequently by used by a processor to implement methods described herein. Example physical media may include floppy discs, optical discs (e.g. CDs, mini-CDs, DVDs, HD-DVD, Blu-ray), hard drives, punch cards, tape drives, flash memory, or memory chips. However, any other type of tangible, persistent storage that can serve in the role of providing instructions to a processor may be used to store the instructions in these embodiments.

### CONCLUSION

Identifiers, such as “(a),” “(b),” “(i),” “(ii),” etc., are sometimes used for different elements or steps. These identifiers are used for clarity and do not necessarily designate an order for the elements or steps.

Embodiments of the present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for providing news, comprising:
determining, by at least one processor, a geographic area;
selecting, by the at least one processor, one or more stories associated with the geographic area, wherein the stories are received using a crowdsourced news processing system;
generating, by the at least one processor, map display information for the geographic area including a plurality of selectable indicators, each of the plurality of selectable indicators corresponding to one of the one or more stories;
positioning, by the at least one processor, a first selectable indicator at an area adjacent to an event location associated with a first story when the first selectable indicator overlaps with a second selectable indicator; and
transmitting, by the at least one processor, the map display information to an interactive user device.

2. The method of claim 1, wherein a first selectable indicator is positioned at an event location associated with a first story when the first selectable indicator does not overlap with a second selectable indicator.

3. The method of claim 1, further comprising:
receiving from the user device a selection of the first selectable indicator; and
transmitting to the user device, responsive to the selection, details of a story corresponding to the first selectable indicator.

4. The method of claim 1, wherein the first selectable indicator denotes that a corresponding story is associated with a category.

5. The method of claim 1, wherein the selecting is based on a category selection from the interactive user device.

6. The method of claim 1, wherein the selecting is based on a relative importance of a plurality of available stories associated with the geographic area.

7. A news processing system comprising:
at least one processor;
a news distributor configured to be executed by the at least one processor and further configured to:
determine a geographic area;
select one or more stories associated with the geographic area;
generate map display information for the geographic area including a plurality of selectable indicators, each of the plurality of selectable indicators corresponding to one of the one or more stories, wherein the stories are received using a crowdsourced news processing system; and
position a first selectable indicator at an area adjacent to an event location associated with a first story when the first selectable indicator overlaps with a second selectable indicator; and
transmit the map display information to an interactive user device.

8. The system of claim 7, wherein a first selectable indicator is positioned at an event location associated with a first story when the first selectable indicator does not overlap with a second selectable indicator.

9. The system of claim 7, wherein a first selectable indicator is positioned at an area adjacent to an event location associated with a first story when the first selectable indicator overlaps with a second selectable indicator.

10. The system of claim 7, the news distributor further configured to:
receive from the user device a selection of the first selectable indicator; and
transmit to the user device, responsive to the selection, details of a story corresponding to the first selectable indicator.

11. The system of claim 7, wherein the first selectable indicator denotes that a corresponding story is associated with a category.

12. The system of claim 7, wherein the selecting is based on a category selection from the interactive user device.

13. The system of claim 7, wherein the selecting is based on a relative importance of a plurality of available stories associated with the geographic area.

14. A computer-readable device having instructions stored thereon that, when executed by at least one computing device, causes the at least one computing device to perform operations comprising:
determining a geographic area;
selecting one or more stories associated with the geographic area, wherein the stories are received using a crowdsourced news processing system;
generating map display information for the geographic area including a plurality of selectable indicators, each of the plurality of selectable indicators corresponding to one of the one or more stories;
positioning a first selectable indicator at an area adjacent to an event location associated with a first story when the first selectable indicator overlaps with a second selectable indicator; and
transmitting the map display information to an interactive user device.

15. The computer-readable device of claim 14, wherein a first selectable indicator is positioned at an event location associated with a first story when the first selectable indicator does not overlap with a second selectable indicator.

16. The computer-readable device of claim 14, wherein a first selectable indicator is positioned at an area adjacent to an event location associated with a first story when the first selectable indicator overlaps with a second selectable indicator.

17. The computer-readable device of claim 14, further comprising:
receiving from the user device a selection of the first selectable indicator; and
transmitting to the user device, responsive to the selection, details of a story corresponding to the first selectable indicator.

18. The computer-readable device of claim 14, wherein the first selectable indicator denotes that a corresponding story is associated with a category.

19. The computer-readable device of claim 14, wherein the selecting is based on a category selection from the interactive user device.

20. The computer-readable device of claim 14, wherein the selecting is based on a relative importance of a plurality of available stories associated with the geographic area.
